(19) United States
(12) Patent Application Publication
(10) Pub. No.: US 2005/0273507 A1
(43) Pub. Date: Dec. 8, 2005

(54) Method and system for managing heterogeneous resources across a distributed computer network

(76) Inventors: Yong Yan, Fremont, CA (US); Bo Shen, Fremont, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/864,204

(22) Filed: Jun. 8, 2004

(51) Int. Cl. G06F 15/173

(52) U.S. Cl. 709/223

(57) ABSTRACT

A system for managing resources across a distributed computer network has first and second management services. The first management service has resources associated therewith and hosts a resource consumer having a resource capacity demand, and the first management service implements objects for monitoring the status of resources of the first management service so as to obtain a value of capacity for each resource. The obtained value of capacity is compared to the capacity demand of the resource consumer. A resource request is generated according to the difference between the value of capacity value and the capacity demand. The second management service implements objects for receiving the generated resource request. Free resources from a global resource pool are allocated according to the resource request, and the allocated resource is provided to the first management service. An advantage of the invention is that it provides an architecture for automatic resource management.

### FIELD OF THE INVENTION

The present invention relates generally to distributed computer systems and more particularly to a method and system for managing heterogeneous resources across a distributed computer network.

### BACKGROUND OF THE INVENTION

Different resource management systems have been proposed for distributed computing networks (such as a grid computing networks). However, the architecture of existing systems does not allow for resource management of distributed heterogeneous resources according to the resource demand of services.

One type of resource management systems which has been proposed for a grid computing network provides a software toolkit for global data movement, LDAP based information sharing, global resource sharing and certification based authentication.

Unfortunately, resource management systems of this type are not flexible and general enough to address interoperability and sharing amongst heterogeneous resources and applications.

Considerable effort has been expended to develop a general automatic management structure for rich media pervasive commercial services. Rich-media content requires that a service grid guarantees service level agreements in order to provide a guaranteed end-to-end quality of service (QoS) to customers. The service guarantee may include dimensions of resource capacity and time. Indeed, service guarantees for rich media content (for example, streaming media content) typically require that the service guarantee be valid over a sustained period of time.

Generally speaking, existing resource management systems for application with rich-media content, reserve resources for particular services rather than dynamically adjust the allocation of resources between services in response to resource demand. Accordingly, such approaches to resource management are not able to provide a resource capacity guarantee. As a result, these approaches are not able to minimize the cost and complexity of resource management for resource consumers.

Moreover, existing approaches do not appear to provide demand driven resource management automation. Accordingly, it would be highly desirable to provide a resource management system which automatically allocates resources according to the resource demand of a service.

The prior art has not adequately addressed these and other problems. Thus, there remains a need to provide an automatic resource management system for a distributed computer environment.

### SUMMARY OF THE INVENTION

In brief, the invention provides a system for managing resources across a distributed computer network. A first management service hosts a resource consumer having a resource capacity demand, and the first management service implements objects for monitoring the status of resources of the first management service so as to obtain a value of capacity for each resource. The obtained value of capacity is compared to the capacity demand of the resource consumer. A resource request is generated according to the value of capacity value and the capacity demand. A second management service implements objects for receiving the generated resource request. Free resources from a global resource pool are allocated according to the resource request, and the allocated resource is provided to the first management service.

These and other objects of the present invention will no doubt become obvious to those of ordinary skill in the art after having read the following detailed description of the preferred embodiment as illustrated in the drawing figures.

### DESCRIPTION OF THE DRAWINGS

FIG. 1 is a block diagram of a system architecture according to an embodiment of the invention;

FIG. 2 is a block diagram showing the interface between the global resource management service and the domain resource management services in accordance with an embodiment of the present invention;

FIG. 3 is a block diagram of domain resource management system in accordance with an embodiment of the present invention;

FIG. 4 is a block diagram of a global resource management service in accordance with an embodiment of the present invention; and

FIG. 5 is a data flow diagram of a method for managing heterogeneous resources across a distributed computer network according to an embodiment of the present invention.

### DETAILED DESCRIPTION OF THE EMBODIMENTS

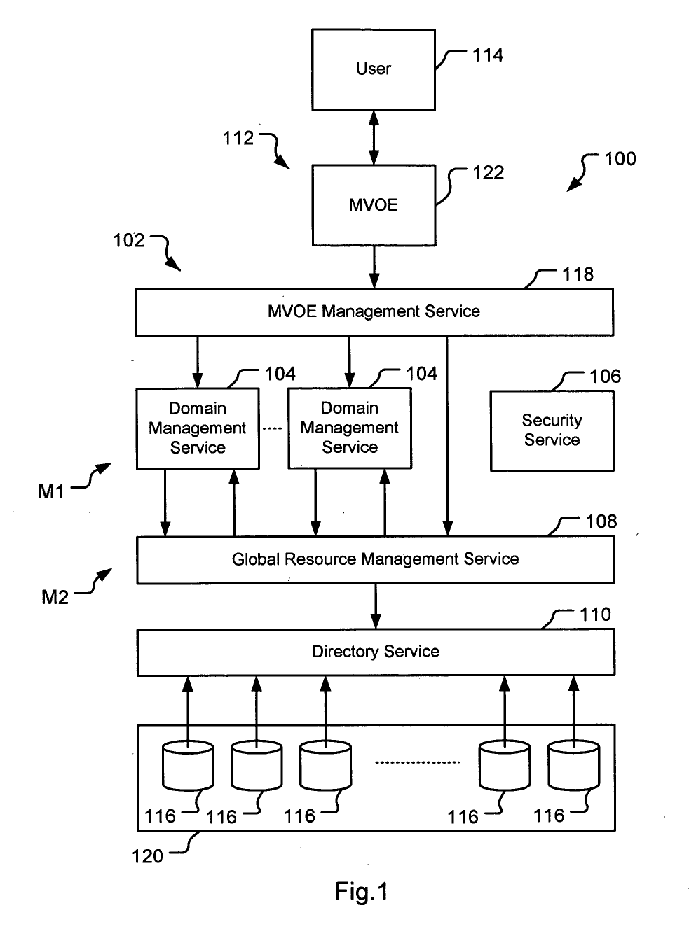

FIG. 1 illustrates a system architecture of a system 100 according to an embodiment. As is shown, the illustrated system 100 includes a first management service M1 and a second management service M2.

In the illustrated embodiment, the first management service M1 is shown as a domain management service 104. As will be described in greater detail herein, the domain management service 104 hosts a resource consumer having a resource capacity demand and the domain resources required to maintain a resource capacity guarantee for the resource consumer.

The second management service M2, shown here as a global resource management service 108, allocates free resources from a global resource pool 120 according to a resource request from a resource consumer hosted by a domain management service 104, and provides the allocated resource thereto.

In the illustrated embodiment, the first management service M1 and the second management service M2 form a part of a system 100 that includes six different types of services, namely a management service 102, the domain management service 104, a security service 106, the global resource management service 108, a directory service 110, and a workstation service 112 (shown here as a multimedia virtual operating environment). It is not essential that the system 100 include a security service 106. Nevertheless, a security service 106 can be provided so as to provide a secure shell around the system 100, particularly in cases where the system 100 includes geographically distributed resources and services. Indeed, for practical use of the system, the security service 106 provides an authentication and access control infrastructure to authenticate each resource request against security threats and control access to services.

The system 100 monitors resources 116 and automatically adjusts the allocation of those resources so as to maintain a resource capacity guarantee for resource consumers. According to an embodiment, the system 100 automatically manages different types of heterogeneous resources 116 by way of using a uniform abstraction of the resources 116 and the services 102, 104, 108, 110, 112. In this way, the system 100 is able to hide resource heterogeneity, and thus reduce resource management complexity.

In one embodiment, the services 102, 104, 106, 108, 110 and 112 are web services. In such an embodiment, the loosely coupled, language-neutral nature, and platform independent features of the emerging web service standard (also referred to as the web service model) may be used to support the uniform abstraction of resources 116 and the services 102, 104, 108, 110, 112. Thus in an embodiment, the resources 116 are also abstracted as web-services. Indeed, in an embodiment, both the resources 116 and the resource consumers are uniformly designed and implemented as web-services based on a general abstraction mechanism. In the present case, the general abstraction mechanism is a service agent.

As will be described in greater detail herein, each of the services 102, 104, 106, 108, 110, and 112, runs on top of a respective service agent. In this respect, each service agent provides a general messaging and deployment engine so as to allow for extensibility, service deployment automation, and enforcement transparency.

In an embodiment, each service agent includes a service agent core for supporting the web service model. In one embodiment, a service agent core includes a common message-passing protocol (such as a simple object access protocol) remote procedure call marshalling/de-marshalling engine, a service publish interface, and a local service publish engine. In an embodiment, each service agent core publishes a Java class as a web-service by generating its WSDL and providing it with a SOAP RPC messaging interface.

To support automatic deployment, each service agent includes a file management service to provide platform-independent file operations on heterogeneous resources 116. The file management service provides basic operations for accessing files and directories. Based on the file management service, an on-site publish service moves a local service (or a local Java class) to a remote node and publishes it there to execute.

To support the self-management capability of resource consumers, a service controller management service manages service controllers which control and monitor the execution of a service. In an embodiment, the monitoring of high level services (such as reading resource usage) and low level services (such as disk capacity, disk, network I/O load and CPU load) is platform-dependent.

From a user's point of view, the workstation service 112 is provided for a user 114 to access and/or manage system 100 functions. Indeed, in the present case, the workstation service 112 is the only platform-dependent service which performs platform-dependent monitoring and resource control while abstracting an underlying physical resource into a virtual resource.

In the present case, the workstation service 112 is a multimedia virtual operating environment (MVOE) 122 which provides a universal multimedia interface for accessing, programming, and managing multimedia services, such as remote collaboration, video-conferencing, streaming media, gaming, remote visualisation and the like. In one embodiment, the MVOE 122 may be a mixture of text, audio, video and graphics. In some embodiments, the MVOE 122 may be able to be hosted on different device types, for example, a desktop computer, a thin client, or a personal digital assistant.

In an embodiment where the workstation service 112 is a MVOE 122, the management service 102 is an MVOE management service 118. Here, the MVOE management service 118 provides for server-side management of user-profile customized MVOE'S.

In terms of the accessing the other services, in one embodiment the security service 106 is the only trusted identity in the system 100 which provides authentication and access control management for the accessing of the other services.

The directory service 110 maintains dynamic and static information (in the form of a static profile) about free global resources 116 which are allocatable from the global resource pool 120. In this respect, in one embodiment, the directory service 110 maintains three types of information about the system 100, namely user profiles that contain user information, resource profiles that contain all static information about resources, and resource domain indexing files where each file indexes the resource in the global resource pool 120 that belong to a resource domain. In addition, the directory service 110 also monitors the global resources 116.

In one embodiment, the directory service 110 may maintain a distributed directory hierarchy for scaleability based on the distribution and the number of global resources 116. However, in the illustrated embodiment only one directory is used.

According to an embodiment, the directory service 110 uses a published-subscribe model to enable the global resources 116 to publish their respective dynamic and static information into the directory and for the global resource management service 108 to allocate global resources 116 to a domain management service 104 as and when required.

Each domain management service (DMS) 104 is dynamically generated based on a resource demand description that is submitted by a resource user (or a self-managing service). The domain management service 104 will be described in more detail later.

The global resource management service 108 allocates resources from a global free resource pool 120 into a domain management service 104. The global resources 116 themselves maybe geographically distributed across multiple administration domains and have heterogeneous types.

Each of the domain management services 104 is responsible for achieving a resource capacity guarantee. This entails dynamically monitoring domain resource (that is, the resources allocated to a domain management service 104) capacity and adaptively adjusting the domain resource allocation from the global resource management service 108 so as to endeavour to maintain a particular domain resource capacity. In this respect, the global resource management service 108 may dynamically adjust the resource allocations among different domain management services 104 so as to maximize overall system performance and profit.

In terms of the security service 106, in one embodiment, during a deployment process the security service 106 is the first service to be deployed so as to provide access control and authentication for the subsequent deployment of other services. For example, when the global resource management service 108 is deployed, it must receive a service ticket to the directory service 110 from the security service 106 before it can serve any resource requests.

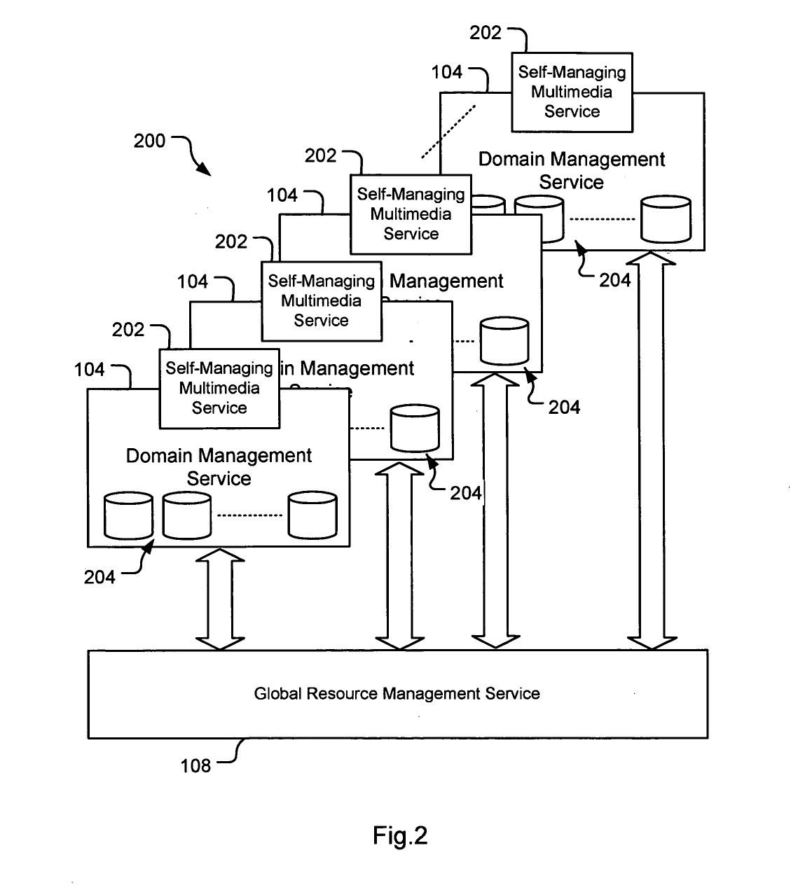

As is shown in FIG. 2, the system 100 (ref. FIG. 1) uses a two-level automatic resource management approach 200, including the global resource management service 108 and the domain management services 104, so as to provide a cost-bounded capacity guarantee for a resource consumer (such as a self-managing multimedia services 202).

As described previously, in an embodiment, a cost-bounded capacity guarantee is achieved by dynamically adjusting the resource allocation between the domain management services 104 and the global resource management service 108 so as to hide failures and load perturbation on domain resources 204.

Accordingly, each domain management service 104 effectively provides an exclusive resource container for the self-managing multimedia service 202 hosted by it, and by cooperating with the global resource management service 108 a domain management service 104 is able to dynamically request or trade domain resources 204 so as to deliver a capacity guarantee at a minimal cost to a respective self-managing multimedia service 202.

In one embodiment, each domain management service 104 is a distributed service which enforces a single sign-on secure domain using a suitable security infrastructure. The domain management service 104 also provides a general management mechanism having a programmable interface which allows the high-level self-managing services 202 to set management policies.

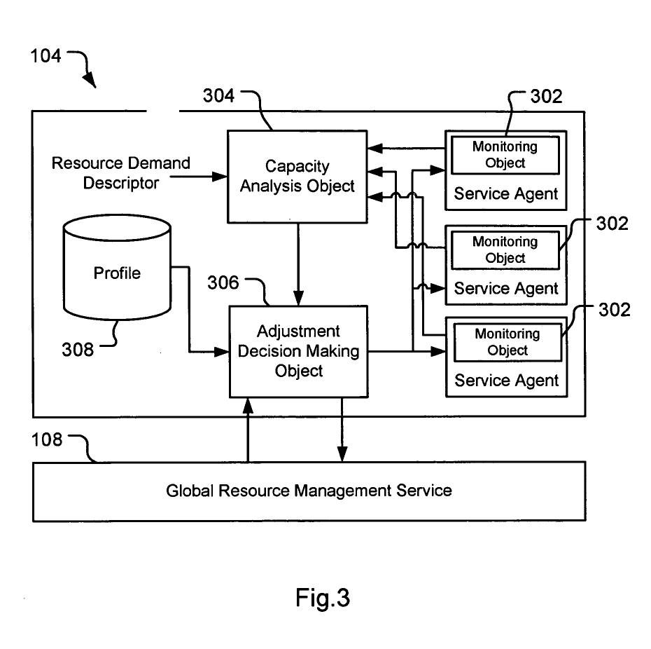

As is shown in FIG. 3, in an embodiment, resource management automation in the domain management service 104 is implemented by four service objects, namely:
(a) a monitoring object 302;
(b) a capacity analysis object 304;
(c) an adjustment decision-making object 306; and
(d) a profile object 308.

The monitoring object 302 monitors resources associated with the domain management service 104 so as to obtain a value of capacity for each resource. In an embodiment, the monitoring of the resources associated with the domain management service 104 entails the monitoring object 302 periodically collecting local resource health information and returning a health report to the capacity analysis object 304. In an embodiment, the contents of a health report may be programmable. In one embodiment, a health report may include basic health information of monitored resources such as node heart-beat (that is, whether a node is alive or dead), and detailed health information such as CPU load, storage load, and network load. Moreover, since a unit of a monitored resource may be shared across multiple services, the detailed health information may reveal service-isolated performance.

In an embodiment, the capacity analysis object 304 compares the obtained value of capacity to the resource capacity demand of the resource consumer so as to obtain a difference value therebetween. In one embodiment, this entails the capacity analysis object 304 collecting health reports from all domain resources 204 (ref. FIG. 2) and periodically taking a snapshot of the domain resource 204 (ref. FIG. 2) capacity. If the capacity snapshot doesn't meet the resource capacity demand, the capacity analysis object 304 sends a capacity deficit report to the adjustment decision-making object 306.

In the embodiment illustrated, the adjustment decision-making object 306 generates a new resource request according to the difference value obtained by the capacity analysis object 304. In one embodiment, the generation of the new resource request includes accessing records of prior resource requests and corresponding difference values so as to generate the new resource request based on prior adjustment decisions. In either case, the new resource request is provided to the global resource management service 108.

In an embodiment, a profile object 308 includes the records of previous adjustment decisions and corresponding capacity deficits so that the adjustment decision-making object 306 is able to enhance its decision precision based on a profiled experience. The making of the adjustment decision, and thus the generation of the new resource request, based upon a profiled experience is expected to offer further advantages because the capacities of some shared resources, such as network and commodity operating systems, are nondeterministic. Thus, even though resource reservation may be a solution, it is not cost effective or practical in a grid computing environment which supports a large number of services in a global area. Similarly, a resource fault is another nondeterministic factor which presents difficulties in guaranteeing a resource capacity.

In the illustrated embodiment, resource requests generated by the domain management services 104 are received by the global resource management service (GRMS) 108 and executed so as to allocate free resources from a global resource pool 120 (ref. FIG. 1) according to the resource request so as to provide the allocated resource to the domain management service 104.

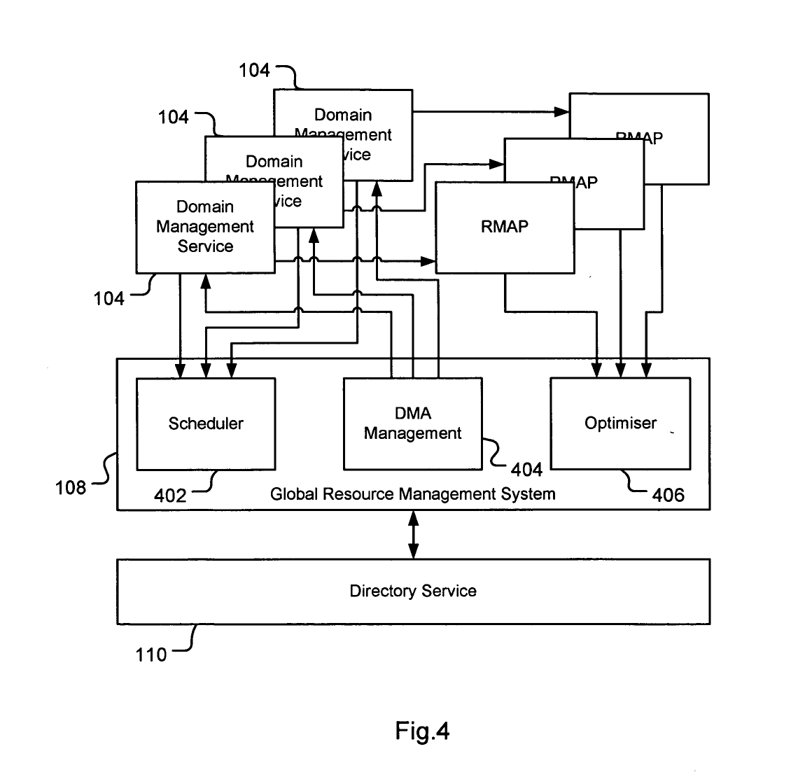

Turning now to FIG. 4 there is illustrated a block diagram of a global resource management system 108 of an embodiment. In the illustrated embodiment, the global resource management system 108 includes three objects, namely:
(a) a scheduler 402:
(b) a DMS management object 404; and
(c) an optimizer 406.

The scheduler 402 allocates free resources from the directory service 110. A resource request could include a request for any combination of different kinds of resources. In an embodiment, the allocation is derived by specific performance metrics that are programmable. For example, the performance metric can be cost, profit, or the number of self-managing services.

The DMS management component 404 creates a DMS 104 for an incoming domain request, conducts DMS placement (that is, the allocation of resources to a DMS), and monitors each DMS 104.

The optimizer 406 attempts to locate “better resources” in the global space or may switch resources among different DMS's so as to optimise the resource allocation from the global view. In this respect, a “better resource” may be measured in terms of a programmable metric.

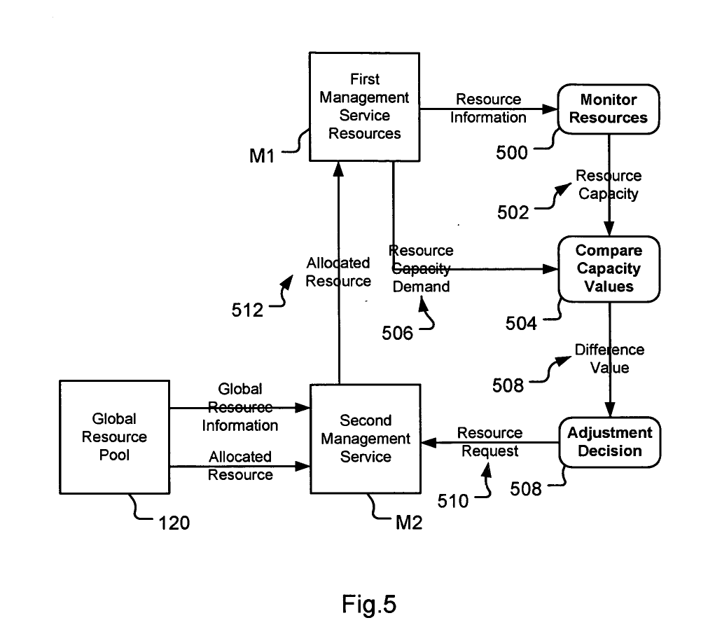

FIG. 5 shows a data flow diagram of a method in accordance with an embodiment. Step 500 monitors the resources of the first management service M1 hosting a resource consumer having a resource capacity demand so as to obtain a value of capacity 502 for each resource of the first management service M1.

Step 504 compares the obtained value of capacity 502 to the capacity demand 506 of the resource consumer so as to allow generation (at step 508) of a resource request 510 according to a difference 508 between the value of capacity 502 and the resource capacity demand 506.

As is shown, the resource request 510 is then provided to the second management service that then allocates free resources from the global resource pool 120 according to the resource request 510. Allocated resources 512 are then provided to the first management service M1.

It is envisaged that the system and method of the present invention will find use in automating the resource management in an open grid infrastructure.

Although the present invention has been described in terms of the presently preferred embodiments, it is to be understood that the disclosure is not to be interpreted as limiting. Various alterations and modifications will no doubt become apparent to the skilled in the art after having read the above disclosure. Accordingly, it is intended that the appended claims be interpreted as covering all alterations and modifications as fall within the true spirit and scope of the invention

1. A system for managing heterogeneous resources across a distributed computer network, comprising:
a first management service having resources associated therewith, the first management service hosting a resource consumer having a resource capacity demand, the first management service implementing objects for monitoring the resources associated with the first management service so as to obtain a value of capacity for each resource, comparing the obtained value of capacity to the resource capacity demand of the resource consumer so as to obtain a difference value, and generating a resource request according to the difference value;
a second management service implementing objects for receiving the resource request, allocating free resources from a global resource pool according to the resource request and providing the allocated resource to the first management service.

2. The system of claim 1 wherein the resource consumer is a self-managing multimedia service.

3. The system of claim 2 wherein the allocation of resources from the global resource pool includes processing a performance metric so as to derive the allocation.

4. The system of claim 3 wherein the performance metric is programmable.

5. The system of claim 1 further comprising plural first management services, wherein the second management service is capable of adjusting resource allocations amongst the plural first management services so as to optimise system performance.

6. The system of claim 5 wherein each first management service is dynamically generated according to a resource demand description, and wherein each resource demand description is submitted by a resource consumer to the second management service.

7. The system of claim 1 wherein the first management service and the second management service are web-services.

8. The system of claim 7 wherein each web-service is based on a service agent having objects for implementing a messaging engine for uniforming service interoperation and a web-publish mechanism for automating service deployment.

9. The system of claim 1 wherein the generating of a resource request includes generating the resource request based on prior resource requests and corresponding difference values.

10. A method for managing heterogeneous resources across a distributed computer network, comprising:
monitoring resources of a first management service hosting a resource consumer having a resource capacity demand, the monitoring obtaining a value of capacity for each resource;
comparing the obtained value of capacity to the capacity demand of the resource consumer;
generating a resource request according to a difference between the value of capacity value and the capacity demand;
receiving the resource request into a second management service;
the second management service allocating free resources from a global resource pool according to the resource request; and
providing the allocated resource to the first management service.

11. The method of claim 10 wherein the generating of a resource request includes accessing a profile object, the profile object including records of prior resource requests and corresponding difference values, so that the generated resource request is derived from the profile object.

12. One or more computer readable media having computer-executable program instructions thereon that when executed by a computer cause:
monitoring of resources of a first management service hosting a resource consumer having a resource capacity demand, the monitoring obtaining a value of capacity for each resource;
comparing of the obtained value of capacity to the capacity demand of the resource consumer;
generation of a resource request according to a difference between the value of capacity value and the capacity demand;
receiving the resource request into a second management service;
the second management service to allocate free resources from a global resource pool according to the resource request; and
providing the allocated resource to the first management service.
